(19) United States
(12) Patent Application Publication
(10) Pub. No.: US 2012/0011331 A1
(43) Pub. Date: Jan. 12, 2012

(54) MEMORY SYSTEM, CONTROLLER AND DEVICE THAT SUPPORTS A MERGED MEMORY COMMAND PROTOCOL

(75) Inventors: Frederick A. Ware, Los Altos Hills, CA (US); John Welsford Brooks, San Jose, CA (US); Kishore Ven Kasamsetty, Cupertino, CA (US); Richard E. Perego, Thornton, CO (US)

(73) Assignee: RAMBUS INC., Los Altos, CA (US)

(21) Appl. No.: 13/141,881

(22) PCT Filed: Mar. 10, 2010
(86) PCT No.: PCT/US2010/026757

§ 371 Date: Jun. 23, 2011

Related U.S. Application Data
(60) Provisional application No. 61/164,656, filed on Mar. 30, 2009.

(51) Int. Cl. G06F 12/00

(52) U.S. Cl. 711/154; 711/E12.001

(57) ABSTRACT

The present embodiments provide a memory system which is configured to send a request from a memory controller to a memory device, wherein the request includes independent activate and precharge commands. The activate command is associated with a row address, which identifies a first row for the activate command. In response to the activate command, the system activates the first row in a first bank in the memory device. Similarly, in response to the precharge command, the system precharges a second bank in the memory device.

### BACKGROUND

1. Field

The present embodiments relate to systems and techniques for communicating between a memory controller device and one or more integrated circuit memory devices.

2. Related Art

As processor clock speeds increase, memory systems are coming under increasing pressure to provide data at correspondingly higher transfer rates. In certain applications, these higher data transfer rates have not been matched by an associated increase in the granularity (size) of each data transfer. Consequently, the higher data transfer rates have led to an increase in “command bandwidth” (the rate at which commands are issued in the memory system). Because of pinout and other constraints for memory controllers, it is desirable to provide this increased command bandwidth without significantly increasing the number of “request pins” which are used to communicate the memory commands.

### BRIEF DESCRIPTION OF THE FIGURES

FIG. 1 illustrates a memory controller coupled to a set of memory devices in accordance with the present embodiments.

FIG. 2 illustrates a sequence of merged memory commands in accordance with the present embodiments.

FIG. 3 presents a flow chart illustrating how a request with independent activate and precharge commands is processed in accordance with the present embodiments.

FIG. 4 presents a flow chart illustrating how a request with two column-access commands is processed in accordance with the present embodiments.

FIG. 5 illustrates a memory device in accordance with the present embodiments.

FIG. 6 presents a timing diagram for an interleaved read transaction in accordance with the present embodiments.

FIG. 7 presents a timing diagram for an interleaved write transaction in accordance with the present embodiments.

FIG. 8 presents a block diagram of an embodiment of a memory system.

### DETAILED DESCRIPTION

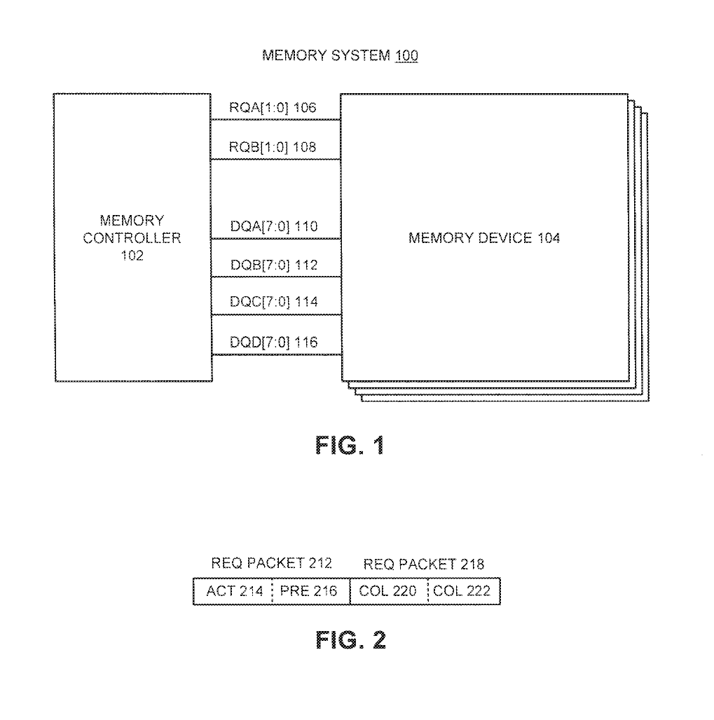

The disclosed embodiments, inter alia, make use of an efficient technique for communicating memory commands from a memory controller to a memory device. In the disclosed embodiments, memory system command bandwidth may be increased by employing a communication protocol that merges independent memory command functionality, each associated with different threads, as a single command (or “request”). By employing this technique, a single memory command effectuates multiple independent memory request functions to occur, where, the multiple memory functions are associated with separate independent memory access requests. For example, referring to FIG. 1, in memory system 100, a memory controller 102 typically communicates with a set of memory devices (including memory device 104) through a number of request lines RQA[1:0] 106 and RQB[1:0] 108. These request lines communicate requests packets containing memory commands from memory controller 102 to memory device 104. (The terms “command” and “request” as used in the present disclosure and the appended claims are interchangeable.) Hence, the term “request packet” is equivalent to the term “command packet.”) A “request” may also be called a “command”. In one embodiment, a “request” is included in a packet format.

In FIG. 1, memory controller 102 is additionally coupled to memory device 104 through a number of data lines DQA[7:0] 110, DQB[7:0] 112, DQC[7:0] 114 and DQD[7:0] 116. During write operations, these data lines transfer data from memory controller 102 to memory device 104. Conversely, during read operations these same data lines transfer data in the opposite direction, from memory device 104 to memory controller 102.

The disclosed embodiments can increase command bandwidth by merging memory commands associated with different threads into the same memory request. In a dynamic random access based memory system, a memory access is initiated when a memory controller sends a request containing an “activate command” to a memory device. The activate command causes the memory device to open a specific row in a specific bank in the memory device. Next, the memory controller sends one or more requests containing column-access commands to the memory device. These column-access commands perform read and/or write operations to the open row. Finally, the memory controller sends a request, which includes a precharge command, to the memory device. This precharge command closes the open row by returning the associated memory bank's sense amplifiers to an idle state.

FIG. 2 illustrates an embodiment of a memory protocol that includes memory command structures that each effectuate multiple independent memory request functions to occur, where the multiple memory functions are associated with separate independent memory access requests (i.e., different threads). For example, FIG. 2 illustrates how a single request 212 can include independent activate 214 and precharge 216 commands, each command associated with different threads. In one embodiment, activate command 214 can include both a bank address (for example, 3 bits) and a row address (for example, 11 bits). However, the precharge command 216 only needs to specify a bank address (3 bits). Hence, the longer activate command 214 can be merged with the shorter precharge command 216 into the single request 212.

Similarly, a single request 218 can include two independent column-access commands 220 and 222, possibly associated with different threads. These two column-access commands 220 and 222 can be readily merged if they share the same bank address. For example, the first column access command 220 can include both a bank address (3 bits) and a column address (6 bits), and the second column-access command 222 can include only a column address (6 bits).

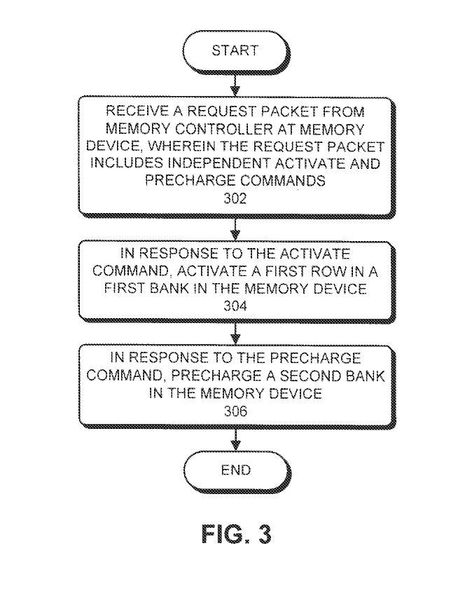

The flow chart in FIG. 3 illustrates how an example request, which includes independent activate and precharge commands, is processed according to an embodiment. During operation, memory device 104 receives a request 212 from memory controller 102, wherein the request includes independent activate and precharge commands (step 302). In response to the activate command, a first row is activated (i.e., sensed) in a first bank in the memory device (step 304). Next, in response to the precharge command, a second bank (that was previously activated) in the memory device is precharged (step 306).

By enabling a precharge command to be specified independently of the associated column-access commands, the associated precharging operation is specified to take place at some time in the future by a future request. This allows the system to hold a row open for a variable amount of time, which enables the system to precharge the row at the latest possible moment, when the system actually needs to access another row in the same bank. This makes it possible to perform a large number of column-access commands to the same row before an associated precharging operation takes place. This protocol may eliminate the need to specify additional precharging operations independently (and possibly additional activate operations), which saves power and conserves command bandwidth. The memory protocol described herein may also flexibly be mixed with independent precharge and/or column access commands or requests to allow the flexibility of incorporation into legacy systems or with different types of memory controllers which require single thread commands/requests.

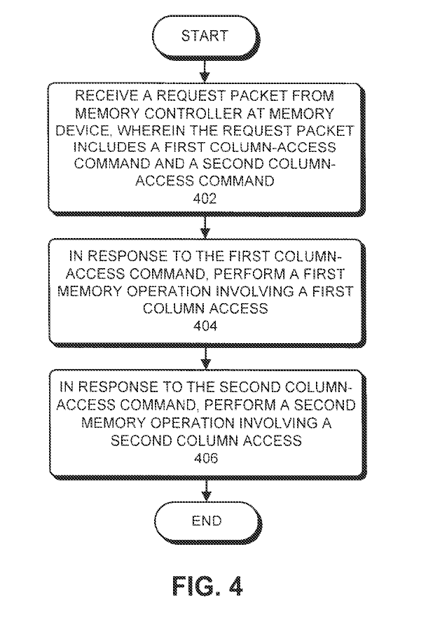

The flow chart in FIG. 4 illustrates how an example request that includes multiple column-access commands is processed according to an embodiment. During operation, memory device 104 receives a request 218 from memory controller 102 at memory device 104, wherein request 218 includes a first column-access command 220 and a second column-access command 222 (step 402). In response to the first column-access command 220, memory device 104 performs a first memory operation involving a first column access (step 404). Next, in response to the second column-access command 222, memory device 104 performs a second memory operation involving a second access (step 406).

### Memory Device

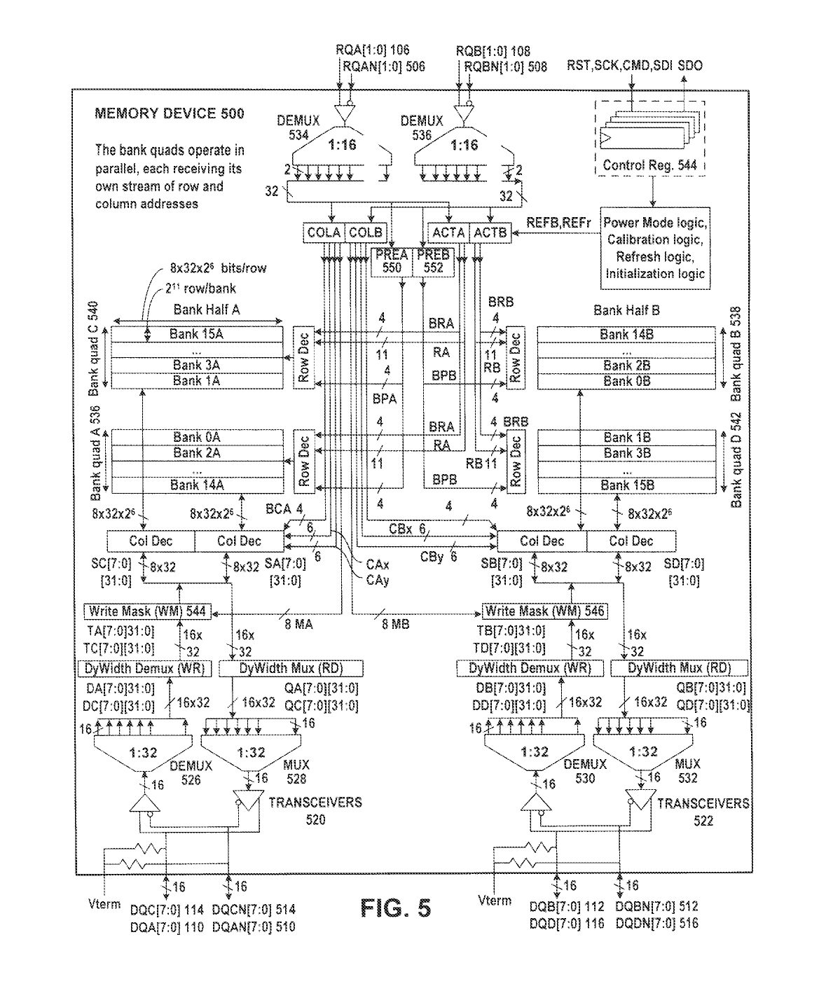

FIG. 5 illustrates an exemplary memory device 500 which supports merged memory commands in accordance with an embodiment. In FIG. 5, memory device provides four memory bank groups (or “quads”), which operate in parallel (namely, bank quad A 536, bank quad B 538, bank quad C 540 and bank quad D 542), wherein each bank receives its own independent stream of row and column accesses.

Each bank quad communicates data through its own set of data lines. More specifically, bank quad A 536 communicates data through eight differential pairs which comprise data lines DQA[7:0] 110 and DQAN[7:0] 510; bank quad B 538 communicates data through data lines DQB[7:0] 112 and DQBN[7:0] 512; bank quad C 540 communicates data through data lines DQC[7:0] 114 and DQCN[7:0] 514; and bank quad D 542 communicates data through data lines DQD[7:0] 116 and DQDN[7:0] 516. Hence, the system includes four independent sets of data lines which are associated with the four bank quads of the memory device. As illustrated in FIG. 5, 32-byte blocks of data are multiplexed (using multiplexers 528 and 532) and de-multiplexed (using demultiplexers 526 and 530) as they are transferred between a bank quad and its associated data lines through transceivers 520 and 522.

These four memory bank quads receive commands through two sets of request lines, namely a first set of request lines RQA[1:0] 106 and RQAN[1:0] 506, which feed through demultiplexer 534, and a second set of request lines RQB[1:0] 108 and RQBN[1:0] 508, which feed through demultiplexer 536. The first set of request lines, RQA[1:0] 106 and RQAN[1:0] 506, provides memory commands for both bank quad A 536 and bank quad C 540, and the second set of request lines, RQB[1:0] 108 and RQBN[1:0] 518, provides memory commands for both bank quad B 538 and bank quad D 542. In an embodiment, this sharing of request lines is facilitated by the above-described merging of two commands into each request. Also, these commands feed into precharging circuitry 550 which precharges bank quad A 536 and bank quad C 540, and precharging circuitry 552 which precharges bank quad B 538 and bank quad D 542. In some embodiments, this precharging circuitry 550 and 552 examines a delay field in a precharge command to determine whether to delay the associated precharging operation. (Note that this precharge command can be stored in a command register.) Write commands include write-mask bits (in a write-mask-field) which feed into write mask registers 544 and 546. These write-mask bits identify data bytes that are not to be written during the associated write operations

Referring to FIG. 1, in the disclosed embodiments, memory controller 102 schedules requests such that memory commands are issued in a valid sequence, and in a sequence that robustly dictates conflict free operation within a memory device. In particular, memory controller 102 must schedule commands in a manner that results in a row for a given bank being precharged before another row in the same bank is opened.

Moreover, the described techniques are not limited to the specific implementation of a memory device illustrated in FIG. 5. In particular, the described techniques can be applied to memory devices which include differing numbers of data banks, command channels and data channels. Additionally, the described techniques can be applied to memory devices that use different protocols, such as the protocols employed by different types of memory devices, e.g., XDR SDRAM, XDR2 SDRAM, double-data-rate (DDR) synchronous dynamic random access memories (SDRAMs), DDR2 SDRAM, DDR3 SDRAM and single-data-rate SDRAMs and future generations, and non-volatile memories, such as NAND Flash and NOR Flash.

For example, in an embodiment, a double data rate SDRAM device includes a command interface that decodes commands which are received via a number of signal lines, including a row address strobe line (RAS), a column access strobe line (CAS) a write enable signal line (WE) and other signals. These (command) signal lines are sampled synchronously with respect to a rising edge of a clock signal (CK). Commands of the type described above may be received and decoded by the DDR SDRAM to effectuate the merged memory access functions described herein.

### Read Transaction

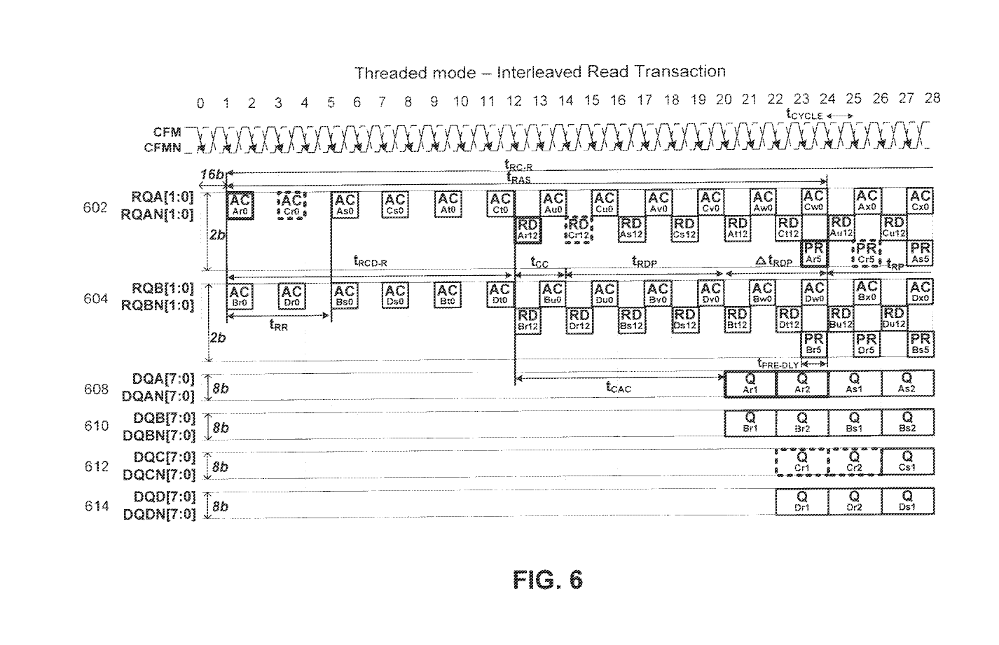

FIG. 6 presents a timing diagram for an interleaved read transaction in accordance with an embodiment. As illustrated in FIG. 6, command channel 602, which comprises request lines RQA[1:0] and RQAN[1:0], carries commands to access bank quad A of a memory device, which, in response communicates data through data channel 608 (via data lines DQA[7:0] and DQAN[7:0]). Command channel 602 additionally carries commands to access bank quad C of the memory device, which, in response, communicates data through data channel 612, (via data lines DQC[7:0] and DQCN[7:0]). Similarly, command channel 604, which comprises request lines RQB[1:0] and RQBN[1:0], carries commands to bank quad B of the memory device, which, in response, communicates data through data channel 610 (via data lines DQB[7:0] and DQBN[7:0]). Command channel 604 additionally carries commands to bank quad B of the memory device, which communicates data through data channel 614, (via data lines DQD[7:0] and DQDN[7:0]).

For example, consider the read transaction comprising the memory commands in boxes highlighted with a thicker line size in FIG. 6. First, an activate command AC_{Ar0}, which opens a row for the read transaction, is sent from memory controller 102 to memory device 104. Next, after a time interval t_{RcD-R}, a column-access read command RD_{Ar12} is sent to memory device 104. (As mentioned above, this column-access read command RD_{Ar12} can comprise two independent column-access commands, possibly associated with different threads, wherein the two column-access commands can share the same bank address.) After a time interval t_{CAC}, read data Q_{Ar1} and Q_{Ar2} is returned from memory device 104 to memory controller 102 through data channel 608.

Finally, a precharge command PR_{Ar5} is sent to memory device 104 to close the open row by returning the associated memory bank's sense amplifiers to an idle state. As illustrated in FIG. 6, this precharging operation takes place after a delay t_{PRE-DLY}. (As mentioned above, this delay can be specified by a delay field in the precharge command.)

Moreover, this precharge command PR_{Ar5} can be sent in the same packet as an independent activate command associated with another memory operation. For example, referring to FIG. 6, precharge command PR_{Ar5} is sent concurrently (in the same packet) with independent activate command AC_{Ax0}.

Also, the above-described read transaction takes place concurrently with a second read transaction comprising the memory commands in the dashed boxes in FIG. 6. The commands for this second read transaction are also communicated across command channel 602. However, the commands are directed to a different memory bank quad, namely bank quad C, and the read data is returned through a different data channel, namely data channel 612.

### Write Transaction

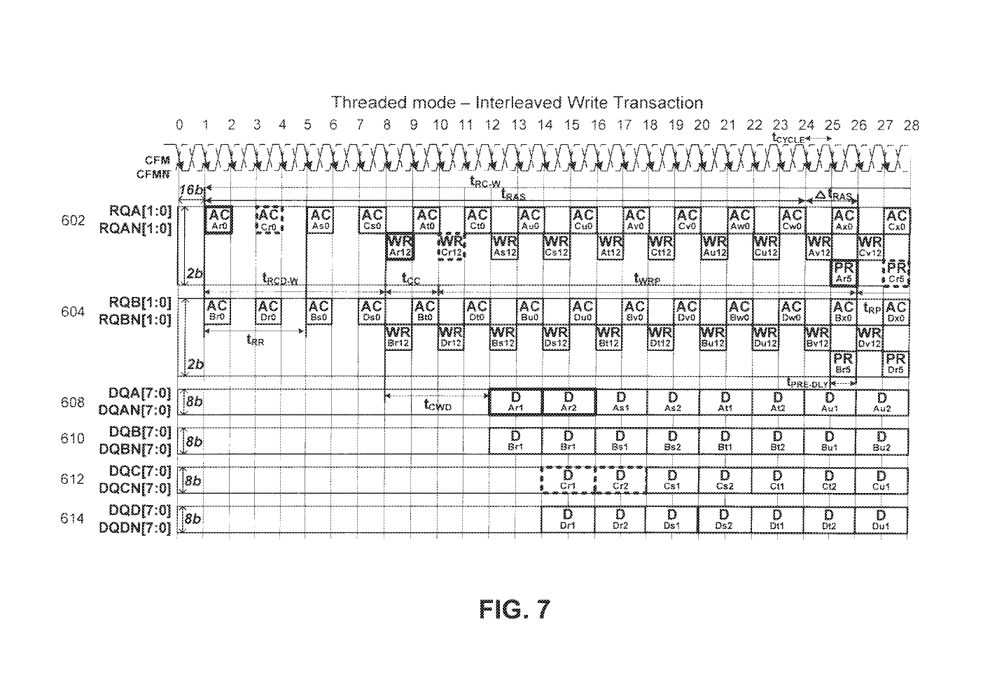

FIG. 7 presents a timing diagram for an interleaved write transaction in accordance with an embodiment. Consider the write transaction comprising the memory commands in boxes highlighted with the thicker line size in FIG. 7. First, an activate command AC_{Ar0} which opens a row for the write transaction, is sent from memory controller 102 to memory device 104. Next, after a time interval t_{RCD-W}, a column-access write command WR_{Ar12} is sent to memory device 104. (This column-access write command WR_{Ar12} can comprise two independent column-access commands possibly associated with different threads, wherein the two column-access commands can share the same bank address.) After a time interval t_{CWD}, write data D_{Ar1} and D_{Ar2} are sent from memory controller 102 to memory device 104 through data channel 608.

Finally, at some time after the write commands complete, a precharge command, PR_{Ar5} is sent to memory device 104 to close the open row. This precharge command PR_{Ar5} can be sent in the same packet as an independent activate command associated with another memory operation. For example, referring to FIG. 7, precharge command PR_{Ar5} is sent concurrently with independent activate command AC_{Ax0}.

Also, the above-described write transaction takes place concurrently with a second write transaction comprising the memory commands in the dashed boxes in FIG. 7. The commands for this second write transaction are also communicated across command channel 602. However, the commands are directed to a different bank quad, namely bank quad C, and the write data is sent through a different data channel, namely data channel 612.

### Memory System

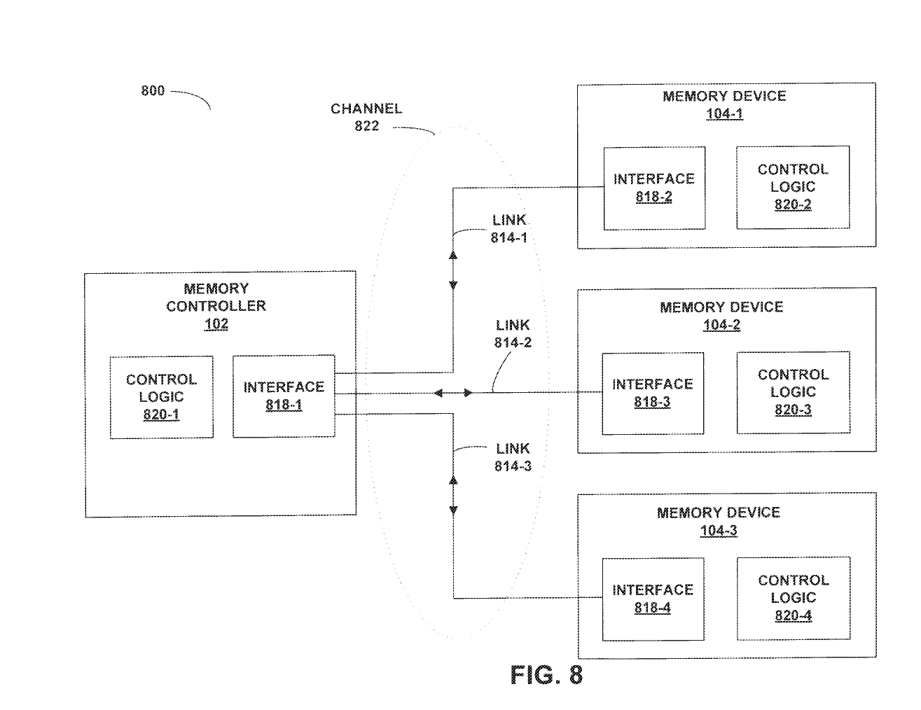

The above-described embodiments may generally be used in a memory system, such as the memory system illustrated in FIG. 8. This memory system includes at least one memory controller 102 and one or more memory devices 104, which may be configured together and disposed on one or more memory modules. While FIG. 8 illustrates memory system 800 having one memory controller 102 and three memory devices 104, other embodiments may have additional memory controllers and fewer or more memory devices 104. Moreover, while memory system 800 illustrates memory controller 102 coupled to multiple memory devices 104, in other embodiments two or more memory controllers may be coupled to one another. Note that memory controller 102 and one or more of the memory devices 104 may be implemented on the same or different integrated circuits, and that these one or more integrated circuits may be included in a chip-package.

In some embodiments, the memory controller 102 is a local memory controller (such as a DRAM memory controller) and/or is a system memory controller (which may be implemented in a microprocessor).

Memory controller 102 may include an input/output (I/O) interface 818-1 and control logic 820-1. As discussed previously with reference to FIGS. 1-6, control logic 820-1 may be used to encode data for transmission by the interface 818-1 to one or more of the memory devices 104 and/or to decode data received by the interface 818-1 from one or more of the memory devices 104 (for example, using a modulation code).

In some embodiments, one or more of memory devices 104 include control logic 820 and at least one of interfaces 818. However, in some embodiments some of the memory devices 104 may not have control logic 820. Moreover, memory controller 102 and/or one or more of memory devices 104 may include more than one of the interfaces 818, and these interfaces may share one or more control logic 820 circuits. Note that in some embodiments two or more of the memory devices 104, such as memory devices 104-1 and 104-2, may include multiple memory bank groups.

Memory controller 102 and memory devices 104 are coupled together by one or more links 814 in a channel 822. While memory system 800 illustrates three links 814, other embodiments may have fewer or more links 814. These links may include: wired, wireless and/or optical communication. Moreover, links 814 may be used for bi-directional and/or uni-directional communications between the memory controller 102 and one or more of the memory devices 104. For example, bi-directional communication between the memory controller 102 and a given memory device may be simultaneous (full-duplex communication). Alternatively, the memory controller 102 may transmit information (such as a data packet which includes a command) to the given memory device, and the given memory device may subsequently provide requested data to the memory controller 102, e.g., a communication direction on one or more of the links 814 may alternate (half-duplex communication). Note that one or more of the links 814 and corresponding transmit circuits and/or receive circuits may be dynamically configured, for example, by one of the control logic 820 circuits, for bi-directional and/or uni-directional communication.

Signals corresponding to data and/or commands (such as request-for-data commands) may be communicated on one or more of the links 814 asynchronously, or alternatively by using a timing reference to either or both edges in one or more timing signals. These timing signals may be generated based on one or more clock signals, which may be: generated on-chip (for example, using a phase-locked loop and one or more reference signals provided by a frequency reference), generated off-chip, and/or recovered from the communicated signals.

In some embodiments, commands are communicated from the memory controller 102 to one or more of the memory devices 104 using a separate command link, e.g., using a subset of the links 814 which communicate commands. This separate command link may be wireless, optical and/or wired. However, in some embodiments commands are communicated using the same portion of the channel 822 (i.e., the same links 814) as data. Moreover, communication of commands: may have a lower data rate than the data rates associated with communication of data between the memory controller 102 and one or more of the memory devices 104; may use different carrier frequencies than are used to communicate data; and/or may use a different modulation technique than is used to communicate data.

The foregoing descriptions of embodiments have been presented for purposes of illustration and description only. They are not intended to be exhaustive or to limit the present description to the forms disclosed. Accordingly, many modifications and variations will be apparent to practitioners skilled in the art. Additionally, the above disclosure is not intended to limit the present description. The scope of the present description is defined by the appended claims.

What is claimed is:

1. A method of operation for a semiconductor memory device, the method comprising:
receiving, from a memory controller, a request at an interface of the memory device, wherein the request includes independent activate and precharge commands;
wherein the activate command is associated with a row address, which identifies a first row for the activate command;
in response to the activate command, activating the first row in a first bank in the memory device; and
in response to the precharge command, precharging a second bank in the memory device.

2. The method of claim 1, wherein the activate command includes a first bank address, which identifies the first bank for the activate command.

3. The method of claim 1, wherein the precharge command includes a second bank address, which identifies the second bank for the precharge command.

4. The method of claim 1, wherein the method further comprises:
receiving a second request from a memory controller at a memory device, wherein the second request includes a first column-access command and a second column-access command;
in response to the first column-access command, performing a first memory operation involving a first column access at the memory device; and
in response to the second column-access command, performing a second memory operation involving a second column access at the memory device.

5. The method of claim 4, wherein the first and second column-access commands include:
two read commands;
two write commands; or
a read command and a write command.

6. The method of claim 5, wherein the second request includes:
a first column address for the first column-access command;
a second column address for the second column-access command; and
a bank address, which is shared by the first and second column-access commands.

7. The method of claim 5, wherein if the first and second column-access commands are both write commands, the second request additionally includes a shared write-mask field which identifies data bytes that are not to be written during the associated write operations.

8. The method of claim 4, wherein the first and second column accesses are performed sequentially.

9. The method of claim 1, wherein if a delay field associated with the precharge command is set, the method further comprises delaying initiation of the precharge command.

10. The method of claim 1, wherein the method further comprises, at the memory controller, scheduling a precharging operation for a target row independently of scheduling preceding column accesses directed to the target row.

11. The method of claim 1, wherein the request is included in a packet protocol, such that receiving the request further includes receiving the request using the packet protocol.

12. The method of claim 1, wherein the precharge command corresponds to a first memory access of the memory device, and the activate command corresponds to a second memory access of the memory device, wherein the second memory access occurs after the first memory access.

13. A method of operation of a memory controller device, the method comprising:
sending a request from the memory controller to a memory device, wherein the request includes independent activate and precharge commands;
wherein the activate command is associated with a row address, which identifies a first row for the activate command;
wherein the activate command causes the memory device to activate a first row in a first bank in the memory device; and
wherein the precharge command causes the memory device to precharge a second bank in the memory device.

14. A memory device, comprising:
a plurality of memory banks;
an input configured to receive a request, wherein the request includes independent activate and precharge commands;
wherein the activate command is associated with a row address, which identifies a first row for the activate command;
wherein in response to the activate command, the memory device is configured to activate the first row in a first bank in the plurality of memory banks; and
a precharging mechanism, wherein in response to the precharge command, the precharging mechanism is configured to precharge a second bank in the plurality of memory banks.

15. The memory device of claim 14, wherein the activate command includes a first bank address, which identifies the first bank for the activate command.

16. The memory device of claim 14, wherein the precharge command includes a second bank address, which identifies the second bank for the precharge command.

17. The memory device of claim 14,
wherein the input is configured to receive a second request wherein the second request includes a first column-access command and a second column-access command;
wherein, in response to the first column-access command, the memory device is configured to perform a first memory operation involving a first column access at the memory device; and
wherein in response to the second column-access command, the memory device is configured to perform a second memory operation involving a second column access at the memory device.

18. The memory device of claim 17, wherein each of the first and second column-access commands include one of:
two read commands;
two write commands; and
a read command and a write command.

19. The memory device of claim 17, wherein the second request includes:
a first column address for the first column-access command;
a second column address for the second column-access command; and
a bank address, which is associated with both the first and second column-access commands.

20. The memory device of claim 19, wherein if the first and second column-access commands are both write commands, the second request additionally includes a shared write-mask field which identifies data bytes that are not to be written during the associated write operations.

21. The memory device of claim 17, wherein the memory device performs the first and second column accesses in a sequence that includes the first column access followed by the second column access.

22. The memory device of claim 14, further comprising a command register configured to store a value representing a delay that transpires before a initiating a precharge operation in response to the precharge command.

23. The memory device of claim 14, wherein the precharge command corresponds to a first memory access of the memory device, and the activate command corresponds to a second memory access of the memory device, wherein the second memory access occurs after the first memory access.

24. The memory device of claim 14, wherein the memory device includes:
a command channel receiver for receiving request; and
multiple data channel transceivers associated with the command channel receiver, wherein the multiple data channel transceivers are configured to transfer data in parallel for multiple memory operations specified by the request received at the command channel receiver.

25. A memory controller, comprising:
an interface to send a request to a memory device, wherein the request includes independent activate and precharge commands;
wherein the activate command is associated with a row address, which identifies a first row for the activate command;
wherein the activate command causes the memory device to activate the first row in a first bank in the memory device; and
wherein the precharge command causes the memory device to precharge a second bank in the memory device.

26. The memory controller of claim 25, wherein the memory controller is configured to schedule a precharging operation for a target row independently of scheduling preceding column accesses directed to the target row.

27. An integrated circuit memory device comprising:
a plurality of memory cells;
an interface to receive a command that effectuates a precharging operation and a sensing operation, wherein the precharging operation is associated with a first memory access of a previously activated first row of memory cells of the plurality of memory cells, and the sensing operation is directed to an activation of a second row of memory cells of the plurality of memory cells for a second memory access that succeeds the first memory access.

28. The integrated circuit memory device of claim 27, wherein the interface receives a command that effectuates first and second column access operations that are directed to a single group of memory cells in the plurality of memory cells.

29. The integrated circuit memory device of claim 28, wherein the interface receives commands using a packet protocol, and the single group of memory cells is an independently addressable bank of the integrated circuit memory device.
